(19) United States
(12) Patent Application Publication
(10) Pub. No.: US 2014/0166477 A1
(43) Pub. Date: Jun. 19, 2014

(54) MULTILAYER-STRUCTURED EXHAUST GAS DECONTAMINATION REACTOR AND METHOD FOR FABRICATING THE SAME

(71) Applicant: National Tsing Hua University, Hsinchu City (TW)

(72) Inventors: Shang-Hsiao WONG, Hsinchu City (TW); Sheng-Shian WU, Hsinchu City (TW)

(73) Assignee: National Tsing Hua University, Hsinchu City (TW)

(21) Appl. No.: 14/070,973

(22) Filed: Nov. 4, 2013

(30) Foreign Application Priority Data
Dec. 18, 2012 (TW) 101148104

(51) Int. Cl. B01D 53/32

(52) U.S. Cl. CPC B01D 53/326
USPC 204/270; 29/890

(57) ABSTRACT

A multilayer-structured exhaust gas decontamination reactor comprises a frame body, a front filter board, a rear filter board, and electrochemical-catalytic conversion units. The front and rear filter boards are respectively installed at an input end and an output end of the frame body and respectively include a plurality of electrochemical-catalytic conversion units that are arranged alternatively. The input end, the interconnection regions of the front and rear filter boards, and the output end jointly form a channel allowing the exhaust gas to flow. The electrochemical-catalytic conversion units of the invention are exposed to the channel to function as the reaction sides for decontaminating the exhaust gas. Thus, the invention does not need to use an additional reducing gas system, thereby can reduce the volume and lower production cost of the exhaust gas decontamination reactor.

### FIELD OF THE INVENTION

The present invention relates to an electrochemical-catalytic converter, particularly to a multilayer-structured exhaust gas decontamination reactor and a method for fabricating the same.

### BACKGROUND OF THE INVENTION

Fresh and clean air is essential for the living of human being. Clean and unpolutant air can secure the health of people. The remarkable advancement of science and technology has greatly promoted economical development. However, the exhaust emission of vehicles and factories, especially motor vehicles and industrial factories, seriously pollutes the air.

The emission standard of motor vehicles is more and more stringent. However, the continuously increasing motor vehicles still bring about more and more serious air pollution. Generally, different types of fuels are burned in a cylinder to release thermal energy and generate dynamic power for engine operation of an automobile. The combustion of fuel also generates exhaust gases including nitrogen oxides (NOx), carbon monoxide (CO), hydrocarbons (HCs), particulate matters (PM), smoke, non-methane hydrocarbons (NMHC), methane (CH₄) and the likes. These pollutants not only form photochemical smog, but also destroy the ozone layer, aggravate the greenhouse effect, cause acid rain, which may damage the ecological environment and endanger human health.

Carbon monoxide comes from incomplete combustion. The capability of carbon monoxide to combine with hemoglobin to form carboxyhemoglobin (COHb) is 300 times higher than the capability of oxygen to combine with hemoglobin to form oxyhemoglobin (HbO₂). Therefore, too high a concentration of carbon monoxide in air will affect the oxygen delivery capability of hemoglobin. Nitrogen oxides are generated by the chemical combination of nitrogen and oxygen and mainly exhausted in form of nitrogen monoxide (NO) and nitrogen dioxide (NO₂). Nitrogen oxides are also likely to combine with hemoglobin and would impair the breathing and circulating functions of human body. Hydrocarbons can irritate the respiratory system even at a lower concentration and will affect the central nervous system at higher concentration.

Therefore, many nations, including EU, USA, Japan and Republic of China, have established stringent exhaust emission standards, such as BINS of USA and EURO 6 of EU, which regulate the exhaust emission standards of nitrogen oxides (NOₓ), carbon monoxide (CO) and hydrocarbons (HCs) to control and decrease the emission of polluted gases and encourage the manufacturers to develop and produce the latest pollution control technologies and products.

In the conventional exhaust emission control technology for rich burn exhaust, no single device or converter can simultaneously undertake the conversion of nitrogen oxides (NOₓ), carbon monoxide (CO) and hydrocarbons (HCs). Most of the catalytic converters of automobile emission systems for the lean burn exhaust can only catalyze the carbon monoxide (CO) and hydrocarbons (HCs). Nitrogen oxides (NOₓ) must be converted by another auxiliary apparatus or system. For example, in addition to an oxidizing catalytic converter for oxidation of carbon monoxide and hydrocarbons, most of the tailpipes of current diesel vehicles are equipped with an EGR (Exhaust Gas Recirculation) system or a cylinder water-spray apparatus to control emission of nitrogen oxides. The latest diesel vehicles may be equipped with an SCR (Selective Catalytic Reduction) system to reduce nitrogen oxides.

The SCR system adopts ammonia (NH₃) or aqueous solution of urea (CO(NH₂)₂) as the reactant. The aqueous solution of urea is injected into the tailpipe via a nozzle and reacted with water to form ammonia. The ammonia reacts with nitrogen oxides to generate nitrogen (N₂) and water (H₂O). However, ammonia is toxic and hard to store and may leak. The incomplete reaction of ammonia causes secondary pollution. Further, the SCR system is bulky and needs to be equipped with precision sensors to provide auxiliary control.

An U.S. Pat. No. 5,401,372 discloses an “Electrochemical Catalytic Reduction Cell for the Reduction of NOₓ in an O₂-Containing Exhaust Emission”, which is a device dedicated to remove nitrogen oxides, and which utilizes electrochemical catalytic reduction reaction and adopts vanadium pentaoxide (V₂O₅) as the catalyst to convert nitrogen oxides into nitrogen. The device has to add a power supply to operate the electrochemical cell thereof. Thus the device of this prior art not only consumes energy resources, but also cannot remove harmful exhaust gases simultaneously.

An US patent of application Ser. No. 13/037,693 disclosed an “Electrochemical-Catalytic Converter for Exhaust Emission Control”, which can eliminate nitrogen oxides (NOₓ), carbon monoxide (CO), hydrocarbons (HC), and particulate matters (PM) in exhaust gas, and which comprises a battery module, wherein nitrogen oxides are electro-catalytically decomposed into nitrogen and oxygen, and wherein carbon monoxide, hydrocarbons, and particulate matters are converted into water and carbon dioxide by an oxidizing catalyst. Therefore, the device of this prior art can remove multiple harmful gases simultaneously.

However, the abovementioned “Electrochemical-Catalytic Converter” needs a reducing-gas system to generate electric potential, which increases the fabrication cost. Further, the unit for heating the circulating reducing gas will expand and contract during operation of the heating unit, which is likely to damage the structure of the anode. Besides, the “Electrochemical-Catalytic Converter” is hard to stack into a compact structure for vehicle application. Therefore, the prior art still has room to improve.

### SUMMARY OF THE INVENTION

The primary objective of the present invention is to solve the problem that the conventional electrochemical-catalytic converter requires an additional reducing-gas system for generating electromotive force, which increase the production cost, the structures are more likely to be damaged, and the volume is hard to be diminished.

To achieve the abovementioned objective, the present invention proposes a multilayer-structured exhaust gas decontamination reactor, which comprises a frame body, a front filter board, a rear filter board, and a plurality of electrochemical-catalytic conversion units. The frame body includes an input end allowing exhaust gas to enter and an output end allowing exhaust gas to discharge. The front filter board is arranged inside the frame body and at one side near the input end. The rear filter board is arranged inside the frame body and at one side near the output end. Each of the front filter board and the rear filter board respectively includes a plurality of filter regions and a plurality of hollow-out interconnection regions. The front filter board and the rear filter board are arranged staggeredly. The electrochemical-catalytic conversion units are arranged in the filter regions. Each electrochemical-catalytic conversion unit includes a first side member, a second side member, and a reducing environment formed between the first side member and the second side member. Each of the first side member and the second side member includes a cathode layer, an anode layer and a solid-state oxide layer between the cathode layer and the anode layer. The anode layer of the first side member is faced to the anode layer of the second side member and is separated from the anode layer of the second side member by the reducing environment.

The input end, the interconnection regions of the front filter board and the rear filter board, and the output end jointly form a channel allowing the exhaust gas to flow. The surfaces of the cathode layers of the electrochemical-catalytic conversion units are exposed to the channel to function as reaction sides for decontaminating the exhaust gas.

To achieve the abovementioned objective, the present invention also proposes a method for fabricating a multilayer-structured exhaust gas decontamination reactor, which comprises steps of:

Preparing a plurality of electrochemical-catalytic conversion units each including a first side member, a second side member and a reducing environment formed between the first side member and the second side member, wherein the first side member and the second side member respectively include a cathode layer, an anode layer and a solid-state oxide layer between the cathode layer and the anode layer, and wherein the anode layer of the first side member faces the anode layer of the second side member is separated from the anode layer of the second side member to form a reducing environment;

Providing a front filter board and a rear filter board that are separated from each other, wherein each of the front filter and the rear filter board includes a plurality of filter regions accommodating the electrochemical-catalytic conversion units and a plurality of hollow-out interconnection regions;

letting the filter regions of the front filter board correspond to the interconnection regions of the rear filter board, and letting the interconnection regions of the front filter board correspond to the filter regions of the rear filter board; and

Preparing a frame body including an input end and an output end, wherein the front filter board is arranged inside the frame body and at one side near the input end and the rear filter board is arranged inside the frame body and at one side near the output end, and wherein the input end, the interconnection regions of the front filter board and the rear filter board, and the output end jointly form a channel allowing the exhaust gas to flow, and wherein surfaces of the cathode layers of the electrochemical-catalytic conversion unit are exposed to the channel to function as the reaction sides for decontaminating exhaust gas.

By means of the abovementioned technical measures, the present invention has the following advantages:
1. The present invention can merely use the cathode layers of the electrochemical-catalytic conversion units to decontaminate exhaust gas without using any additional reducing gas system. Thereby, can lower the production cost and less likely to be damaged.
2. Without the reducing gas system, the present invention can effectively reduce the volume of the reactor. Further, with the assembly of the electrochemical-catalytic conversion units, the front filter board, the rear filter board and the frame body to form a multilayer structure. The reaction area between the reactor and the exhaust gas can be increased and thus to promote the decontamination efficiency.

### BRIEF DESCRIPTION OF THE DRAWINGS

FIG. 1A is a perspective view schematically showing a multilayer-structured exhaust gas decontamination reactor according to one embodiment of the present invention;

FIG. 1B is a sectional view schematically showing a multilayer-structured exhaust gas decontamination reactor according to one embodiment of the present invention;

FIG. 2A is a perspective view schematically showing an electrochemical-catalytic conversion unit according to one embodiment of the present invention;

FIG. 2B is a sectional view schematically showing an electrochemical-catalytic conversion unit according to one embodiment of the present invention;

FIGS. 3A-3D are diagrams schematically showing a method for fabricating an electrochemical-catalytic conversion unit according to one embodiment of the present invention;

FIGS. 4A-4C are diagrams schematically showing a process of fabricating a first side member according to one embodiment of the present invention; and

FIGS. 5A-5C are diagrams schematically showing a process of fabricating an electrochemical-catalytic conversion unit according to one embodiment of the present invention.

### DETAILED DESCRIPTION OF THE PREFERRED EMBODIMENTS

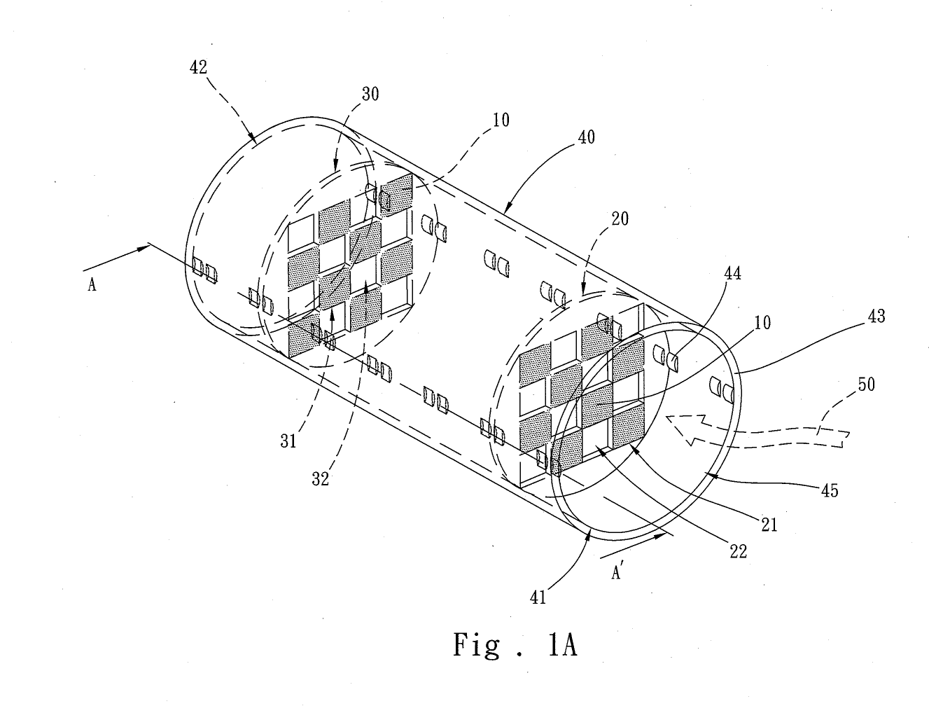

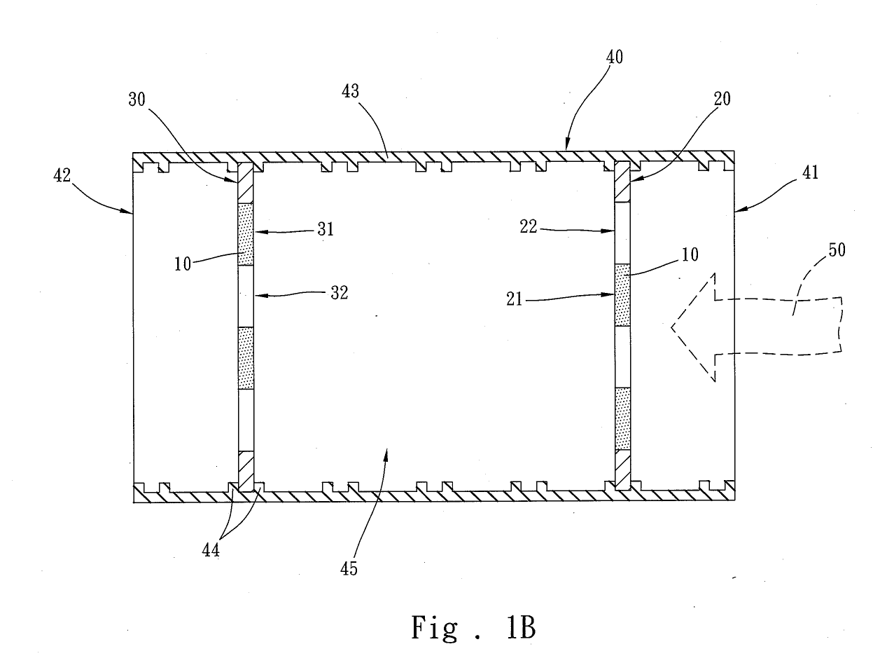

The technical contents of the present invention are described in detail in cooperation with drawings below. Refer to FIG. 1A and FIG. 1B respectively a perspective view and a sectional view of a multilayer-structured exhaust gas decontamination reactor according to one embodiment of the present invention. The multilayer-structured exhaust gas decontamination reactor of the present invention comprises a frame body 40, a front filter board 20, a rear filter board 30 and a plurality of electrochemical-catalytic conversion units 10. The frame body 40 includes a tubular shape shell 43, a plurality of fixing elements 44, an input end 41 and an output end 42. The input end 41 and the output end 42 respectively formed as an inlet and an outlet of the tubular shape shell 43 and allowing exhaust gas 50 to enter and to discharge. The fixing elements 44 are formed on the inner wall of the tubular shape shell 43 and protrude centripetally. Each two fixing elements 44 form a pair and arranged axially along the tubular shape shell 43.

The front filter board 20 is arranged inside the frame body 40 and at one side near the input end 41. The rear filter board 30 is arranged inside the frame body 40 and at one side near the output end 42. Both the front filter board 20 and the rear filter board 30 are installed on the inner wall of the tubular shape shell 43. The front filter board 20 and the rear filter board 30 are respectively press-fitted to the fixing elements 44 near the inlet and outlet. The front filter board 20 includes a plurality of filter regions 21 and a plurality of hollow-out interconnection regions 22. The rear filter board 30 includes a plurality of filter regions 31 and a plurality of hollow-out interconnection regions 32. The filter regions 21 and the interconnection regions 22 are arranged alternately on the front filter board 20, and the filter regions 31 and the interconnection regions 32 are arranged alternately on the rear filter board 30. In this embodiment, the front filter board 20 and the rear filter board 30 can have a circular shape. However, the present invention does not constrain that the front filter board 20 and the rear filter board 30 must have a circular shape. In the present invention, the front filter board 20 and the rear filter board 30 may also have other shapes, wherein the filter regions 21 and the interconnection regions 22 are alternately formed on the front filter board 20, and the filter regions 31 and the interconnection regions 32 are alternately formed on the rear filter board 30, and wherein the front filter board 20 is rotated with respect to the rear filter board 30 by an angle of 90 degrees, whereby the filter regions 21 of the front filter board 20 and the filter regions 31 of the rear filter board 30 are arranged staggeredly.

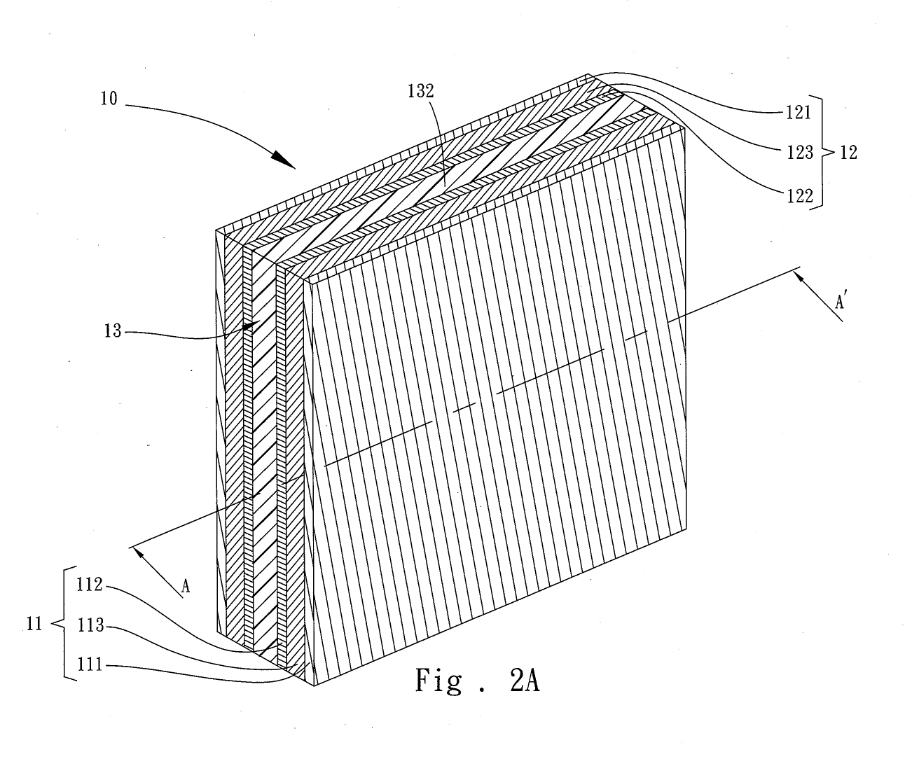

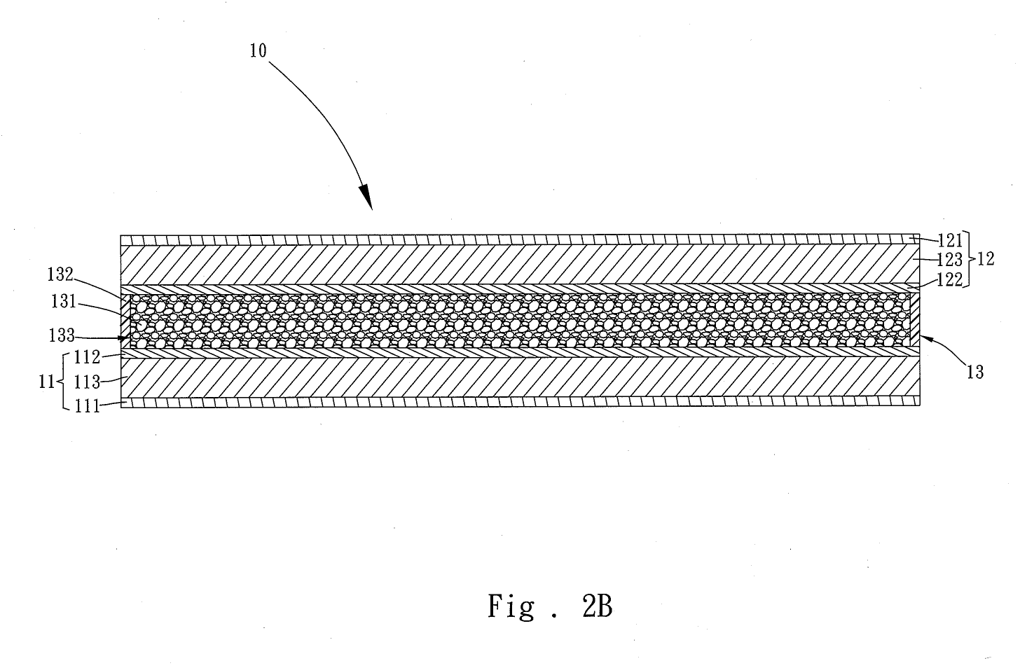

Refer to FIG. 2A and FIG. 2B respectively a perspective view and a sectional view of an electrochemical-catalytic conversion unit according to one embodiment of the present invention. The electrochemical-catalytic conversion units 10 are arranged in the filter regions 21 and 31. Each electrochemical-catalytic conversion unit 10 includes a first side member 11, a second side member 12, and a reducing environment 13 formed between the first side member 11 and the second side member 12. Each first side member 11 includes a cathode layer 111, an anode layer 112 and a solid-state oxide layer 113 between the cathode layer 111 and the anode layer 112. Each second side member 12 includes a cathode layer 121, an anode layer 122 and a solid-state oxide layer 123 between the cathode layer 121 and the anode layer 122. The anode layer 112 of the first side member 11 faces the anode layer 122 of the second side member 12 and is separated from the anode layer 122 of the second side member 12 by the reducing environment 13. The cathode layers 111 and the cathode layers 121 are made of a material selected from a group consisting of perovskite metal oxides, fluorite metal oxides, metal-added perovskite metal oxides, and metal-added fluorite metal oxides. In one embodiment, the cathode layers 111 and the cathode layers 121 are made of made of a perovskite lanthanum strontium cobalt copper oxide, a lanthanum strontium manganese copper oxide, a combination of a lanthanum strontium cobalt copper oxide and a gadolinia-doped ceria; a combination of a lanthanum strontium manganese copper oxide and a gadolinia-doped ceria, a silver-added lanthanum strontium cobalt copper oxide, a silver-added lanthanum strontium manganese copper oxide, a combination of a silver-added lanthanum strontium cobalt copper oxide and a gadolinia-doped ceria, or a combination of a silver-added lanthanum strontium manganese copper oxide and a gadolinia-doped ceria. The anode layers 112 and the anode layers 122 are made of a material selected from a group consisting of cemets of metals and perovskite metal oxides, fluorite metal oxides, metal-added perovskite metal oxides, and metal-added fluorite metal oxides. In one embodiment, the anode layers 112 and the anode layers 122 are made of a nickel-added yttria-stabilized zirconia (Ni-YSZ cermet). The solid-state oxide layers 113 and the solid-state oxide layer 123 are made of a fluorite metal oxide or a perovskite metal oxide. In one embodiment, the solid-state oxide layers 113 and the solid-state oxide layer 123 are made of a fluorite YSZ (yttria-stabilized zirconia), a stabilized zirconia, a fluorite GDC (gadolinia-doped ceria), a doped ceria, a perovskite LSGM (strontium/magnesium-doped lanthanum gallate), or a doped lanthanum gallate.

The reducing environment 13 is formed between the anode layer 112 of the first side member 11 and the anode layer 122 of the second side member 12. In the embodiment, the reducing environment 13 includes an accommodation space 133, a reducing agent 131 and adhesive 132. The accommodation space 133 separates the anode layer 112 of the first side member 11 from the anode layer 122 of the second side member 12. The reducing agent 131 is accommodated in the accommodation space 133. In one embodiment, the reducing agent 131 is a type of solid-state reducing powders, such as graphite powders or carbon black. The adhesive 132 joins the anode layer 112 of the first side member 11 with the anode layer 122 of the second side member 12 and encapsulate the reducing agent 131 inside the accommodation space 133. In one embodiment, the adhesive 132 are made of heat-resistant ceramic putty having a thermal expansion coefficient near that of the solid-state oxide layer 113. The adhesive 132 normally contains aluminum oxides and silicon oxides. Alternatively, the accommodation space 133 is not filled with the reducing agent 131 but directly sealed by the adhesive 132, and having a pressure lowered than 1 atm, e.g. a vacuum state, whereby is also formed a reducing environment.

The input end 41, the interconnection regions 22 and 32 of the front filter board 20 and the rear filter board 30, and the output end 42 jointly form a channel 45 allowing the exhaust gas 50 to flow. The surfaces of the cathode layers 111 and 121 of the electrochemical-catalytic conversion units 10 are exposed to the channel 50 to function as the reaction sides for decontaminating the exhaust gas 50. The reducing environment 13 facilitates the anode layers 112 and 122 and the cathode layers 111 and 121 to generate an electromotive force there between to enable the cathode layers 111 and 121 to undertake a catalytic decomposition reaction of nitrogen oxides of the exhaust gas 50. The staggering arrangement of the front filter board 20 and the rear filter board 30 increases the probability that the electrochemical-catalytic conversion units 10 contact the exhaust gas 50 flowing in the channel 45, whereby is enhanced the capability of the exhaust gas decontamination reactor to decontaminate the exhaust gas 50. In this embodiment, only the front filter board 20 and the rear filter board 30 are installed inside the frame body 40. In other embodiments, a plurality of the front filter board 20 and the rear filter board 30 can be arranged staggeredly inside the frame body 40 to enhance the decontamination capability of the exhaust gas decontamination reactor.

The present invention further proposes a method for fabricating a multilayer-structured exhaust gas decontamination reactor, which comprises Steps 1-4.

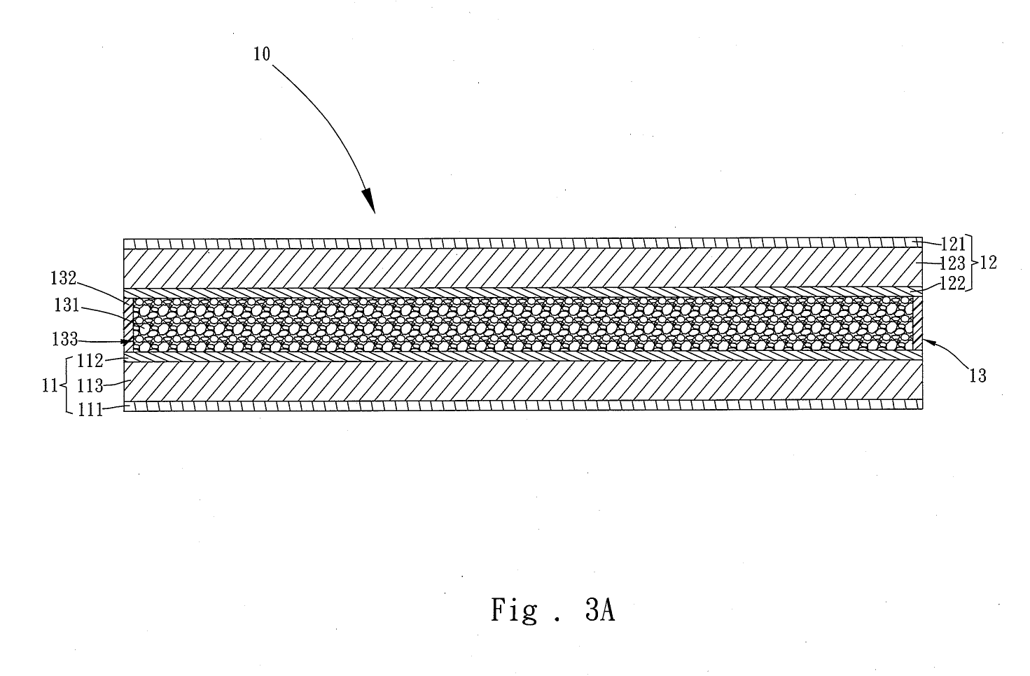

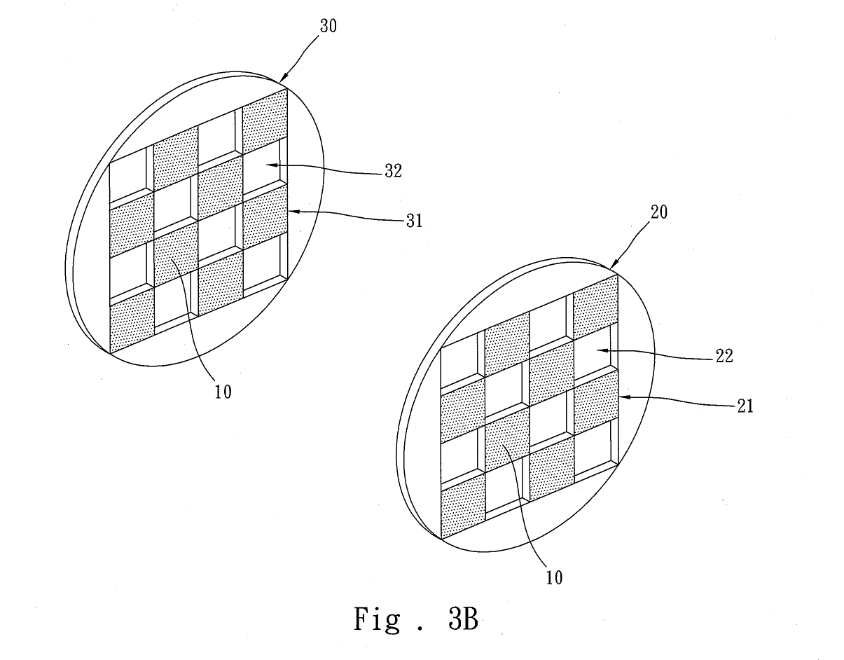

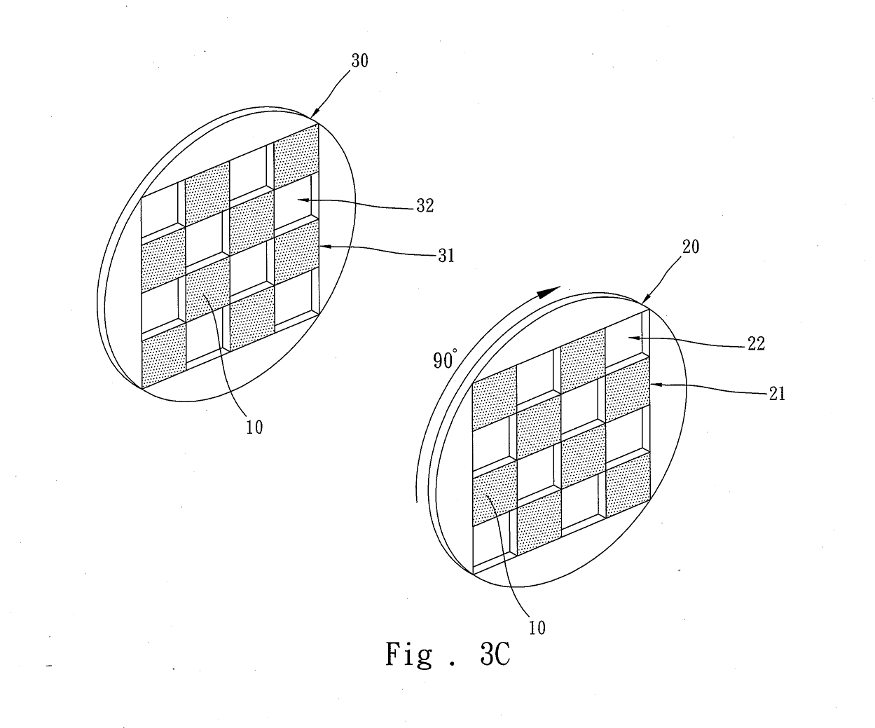

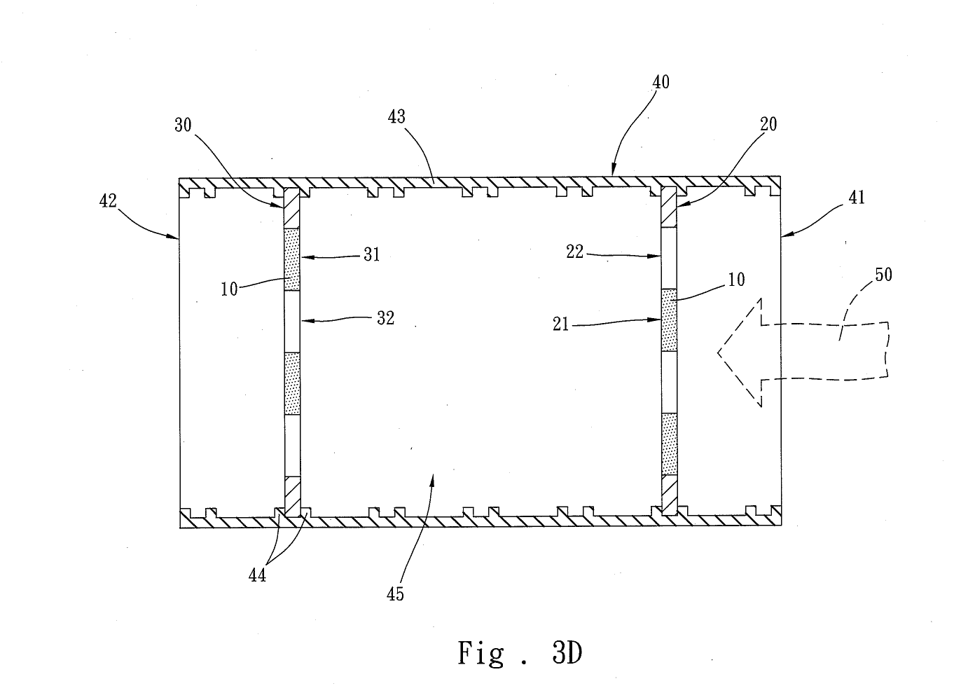

Refer to FIG. 3A. In Step 1, preparing a plurality of electrochemical-catalytic conversion units 10 each including a first side member 11, a second side member 12 and a reducing environment 13 formed between the first side member 11 and the second side member 12, wherein the first side member 11 and the second side member 12 respectively include a cathode layer 111 and 121, an anode layer 112 and 122 and a solid-state oxide layer 113 and 123 between the cathode layer 111 and 121 and the anode layer 112 and 122, wherein the anode layer 112 of the first side member 11 is faces the anode layer 122 of the second side member 12 and is separated from the anode layer 122 of the second side member 12 by the reducing environment 13.

Refer to FIG. 3B. In Step 2, a front filter board 20 and a rear filter board 30 that are spaced from each other are provided, wherein the front filter board 20 and the rear filter board 30 respectively include a plurality of filter regions 21 and 31 accommodating the electrochemical-catalytic conversion units 10 and a plurality of hollow-out interconnection regions 22 and 32. In this embodiment, the filter regions 21 and 31 and the interconnection regions 22 and 32 are arranged alternately on the front filter board 20 and the rear filter board 30. However, the present invention does not constrain the arrangement of the filter regions 21 and 31 and the interconnection regions 22 and 32.

Refer to FIG. 3C. In Step 3, the front filter board 20 and the rear filter board 30 are staggeredly arranged. In this embodiment, the front filter board 20 and the rear filter board 30 have a circular shape. However, the present invention does not constrain that the front filter board 20 and the rear filter board 30 must have a circular shape. In the present invention, the front filter board 20 and the rear filter board 30 may also have other shapes, wherein the filter regions 21 and the interconnection regions 22 are arranged alternately on the front filter board 20, and the filter regions 31 and the interconnection regions 32 are arranged alternately on the rear filter board 30, and wherein the front filter board 20 is rotated with respect to the rear filter board 30 by an angle of 90 degrees, whereby the filter regions 21 of the front filter board 20 and the filter regions 31 of the rear filter board 30 are arranged staggeredly. Thereby increased the probability of the exhaust gas 50, which flows from the front filter board 20 to the rear filter board 30, to contact the electrochemical-catalytic conversion units 10 arranged in the filter regions 21 and the filter regions 31.

Refer to FIG. 3D. In Step 4, a frame body 40 is prepared. The frame body 40 includes an input end 41 allowing the exhaust gas 50 to enter and an output end 42 allowing the exhaust gas 50 to discharge. The front filter board 20 is arranged inside the frame body 40 and at one side near the input end 41. The rear filter board 30 is arranged inside the frame body 40 and at one side near the output end 42. The input end 41, the interconnection regions 22 and 23 of the front filter board 20 and the rear filter board 30, and the output end 42 jointly form a channel 45 allowing exhaust gas 50 to flow and thus is to form the multilayer-structured exhaust gas decontamination reactor. The surfaces of the cathode layers 111 and 121 of the electrochemical-catalytic conversion units 10 are exposed to the channel 50 to function as the reaction sides for decontaminating the exhaust gas 50. The reducing environment 13 facilitates the anode layers 112 and 122 and the cathode layers 111 and 121 to generate an electromotive force there between to enable the cathode layers 111 and 121 to undertake a catalytic decomposition reaction of nitrogen oxides of the exhaust gas 50. In this embodiment, only the front filter board 20 and the rear filter board 30 are installed inside the frame body 40. In other embodiments, a plurality of the front filter board 20 and the rear filter board 30 can be arranged staggeredly inside the frame body 40 to enhance the decontamination capability of the exhaust gas decontamination reactor.

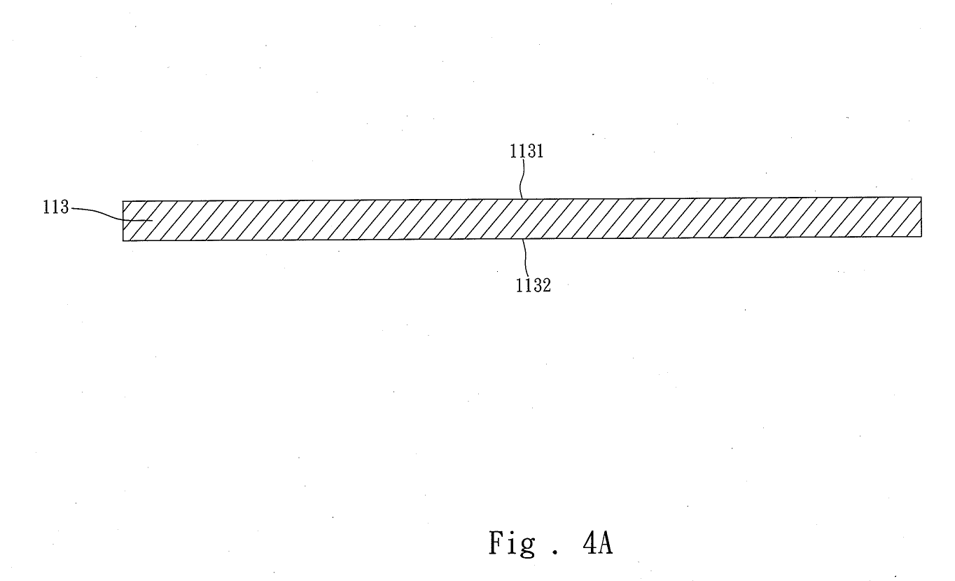

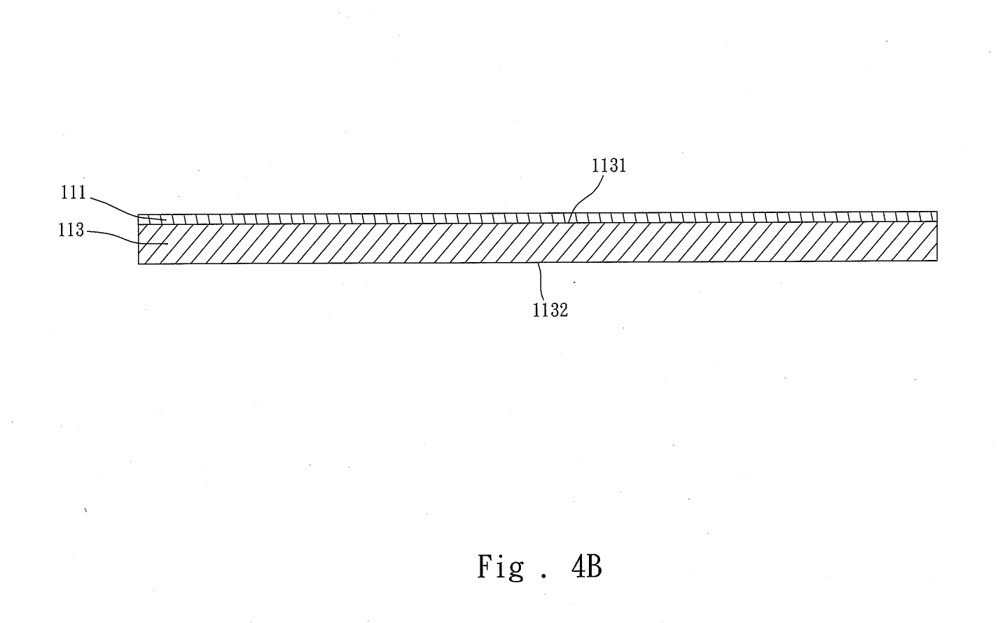

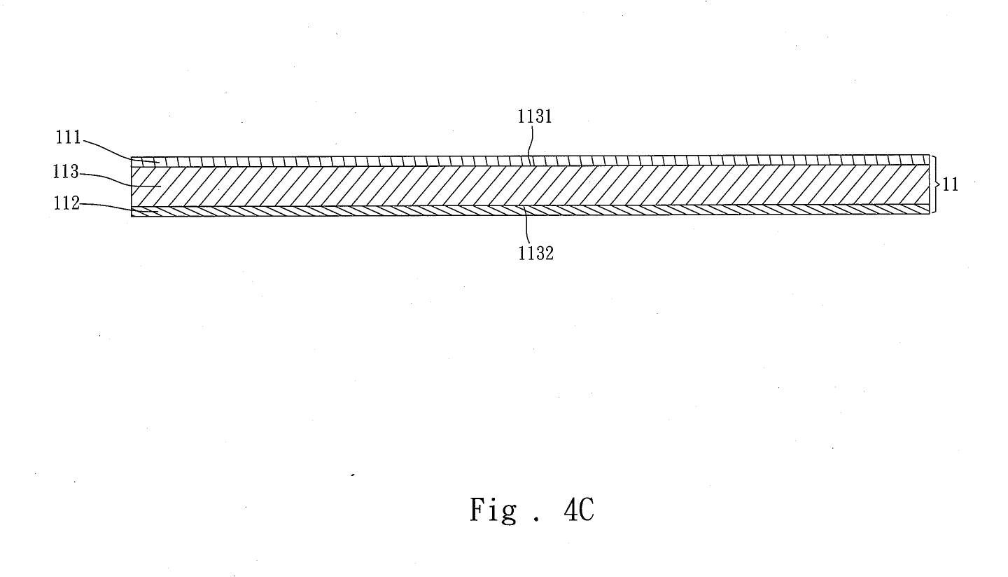

The invention is to be described in more detail how the electrochemical-catalytic conversion unit 10 is fabricated in Step 1. Each electrochemical-catalytic conversion unit 10 includes a first side member 11, a second side member 12 and a reducing environment 13. In one embodiment, the first side member 11 and the second side member 12 are fabricated in advance before they are assembled to form the electrochemical-catalytic conversion unit 10. Refer to FIGS. 4A-4B diagrams schematically showing a method for fabricating the first side member 11 according to one embodiment of the present invention. The method for fabricating the first side member 11 can be described as follows:

Refer to FIG. 4A. Firstly, the solid-state oxide layer 113 which includes a cathode surface 1131 and an anode surface 1132 far away from the cathode surface 1131 is provided. The solid-state oxide layer 113 is made of a fluorite metal oxide or a perovskite metal oxide, such as a fluorite YSZ (yttria-stabilized zirconia), a stabilized zirconia, a fluorite GDC (gadolinia-doped ceria), a doped ceria, a perovskite LSGM (strontium/magnesium-doped lanthanum gallate), or a doped lanthanum gallate. In this embodiment, the solid-state oxide layer 113 is a plate made of zirconia.

Refer to FIG. 4B. Next, coating a cathode material on the cathode surface 1131, and performing a first sintering process for the cathode material to form the cathode layer 111 on the cathode surface 1131. The cathode material is selected from a group consisting of perovskite metal oxides, fluorite metal oxides, metal-added perovskite metal oxides, and metal-added fluorite metal oxides. For example, the cathode layer 111 is made of a perovskite lanthanum strontium cobalt copper oxide, a lanthanum strontium manganese copper oxide, a combination of a lanthanum strontium cobalt copper oxide and a gadolinia-doped ceria, a combination of a lanthanum strontium manganese copper oxide and a gadolinia-doped ceria, a silver-added lanthanum strontium cobalt copper oxide, a silver-added lanthanum strontium manganese copper oxide, a combination of a silver-added lanthanum strontium cobalt copper oxide and a gadolinia-doped ceria, or a combination of a silver-added lanthanum strontium manganese copper oxide and a gadolinia-doped ceria. The coating is performed by a spin-coating machine, wherein tiny droplets of the cathode material are sequentially dripped on the cathode surface 1131 one by one for spin-coating lest the cathode layer 111 be too thick or uneven. However, the present invention does not constrain that the cathode material must be coated by a spin-coating machine. The cathode material may alternatively be coated by a scraper while the cathode surface 1131 has a larger area. The first sintering process is to degrease the cathode material and sinter the cathode material to form the cathode layer 111. The procedures and cycles of heating and cooling are dependent on the selected cathode material.

In one embodiment, a combination of a lanthanum strontium cobalt manganese oxide and a gadolinia-doped ceria is used as the cathode material. Firstly, spray a fluorite gadolinia-doped ceria on the cathode surface 1131, and dry the cathode material in an oven at a temperature of 50° C. for 6 hours. Then, heat the cathode material at a temperature-rising speed of 5° C./min to undertake heat treatments. At beginning, heat the cathode material from an ambient temperature to a temperature of 600° C., and soak the cathode material at the temperature of 600° C. for 2 hours. Next, raise the temperature of the oven to a temperature of 900° C., and soak the cathode material at the temperature of 900° C. for 2 hours. Next, raise the temperature of the oven to a temperature of 1200° C., and soak the cathode material at the temperature of 1200° C. for 4 hours. Next, cool the cathode material at the same speed through the same lengths of soaking time to an ambient temperature. The cathode layer 111 is then formed.

Refer to FIG. 4C. Finally, coating an anode material on the anode surface 1132, and performing a second sintering process for the anode material to form the anode layer 112 on the anode surface 1132, and thereby is completed the first side member 11. The anode material is selected from a group consisting of cemets of metals and fluorite metal oxides, perovskite metal oxides, metal-added fluorite metal oxides, and metal-added perovskite metal oxides. For example, the anode material is a nickel-added yttria-stabilized zirconia (Ni-YSZ cermet).

In one embodiment, a combination of nickel oxide and the Ni-YSZ cermet is selected as the anode material. Initially, spray the anode material on the anode surface 1132. Then, undertake the second sintering process. Firstly, dry the anode material in an oven at a temperature of 50° C. for 6 hours. Next, heat the anode material at a temperature-rising speed of 5° C./min to undertake heat treatments. At beginning, heat the anode material from an ambient temperature to a temperature of 300° C., and soak the anode material at the temperature of 300° C. for 2 hours. Next, raise the temperature of the oven to a temperature of 600° C., and soak the anode material at the temperature of 600° C. for 2 hours. Next, raise the temperature of the oven to a temperature of 900° C., and soak the anode material at the temperature of 900° C. for 4 hours. Next, cool the anode material at the same speed through the same lengths of soaking time to an ambient temperature. The objective of the second sintering process is the same as that of the first sintering process and will not repeat herein. As a combination of nickel oxide and the Ni-YSZ cermet is used as the anode material, the second sintering process is different from the first sintering process in that nickel oxide needs to be reduced into nickel metal. Therefore, the anode material together with the solid-state oxide layer 113 is placed in a quartz tube for a reducing heat treatment. The quartz tube is filled with hydrogen, heated at a temperature-rising speed of 5° C./min to a temperature of 400° C., and soaked at the temperature of 400° C. for 8 hours to reduce the combination of nickel oxide and the Ni-YSZ cermet into nickel metal and the Ni-YSZ cermet without damaging the cathode layer 111. Thereby is formed the anode layer 112 and completed the fabrication of the first side member 11. The fabrication of the second side member 12 is the same as that of the first side member 11 and will not repeat herein.

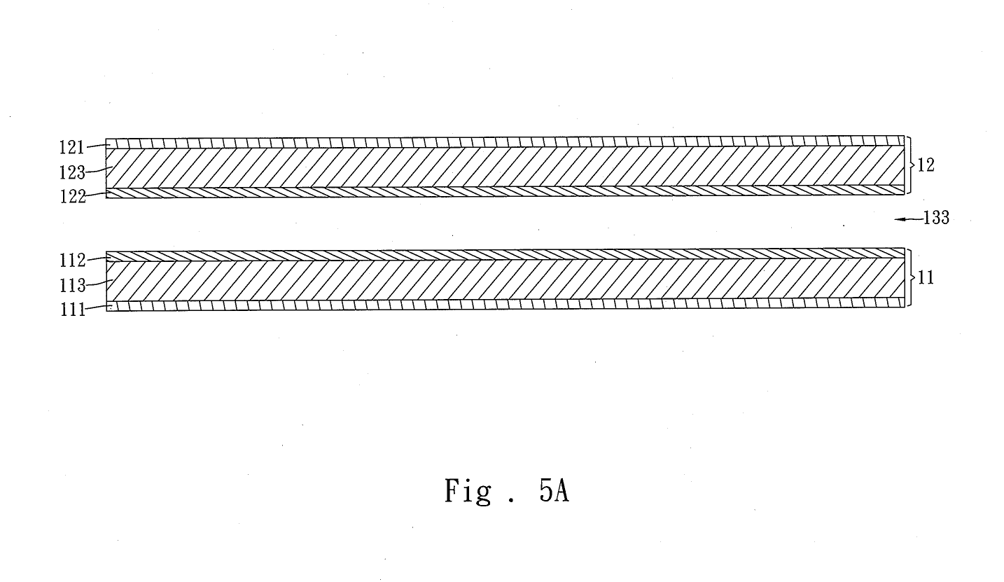

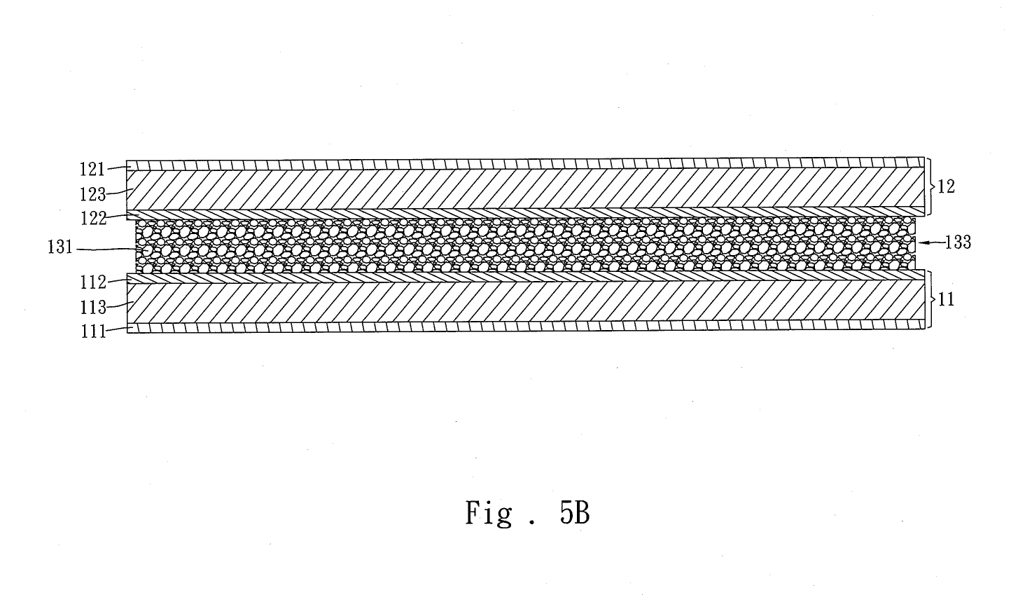

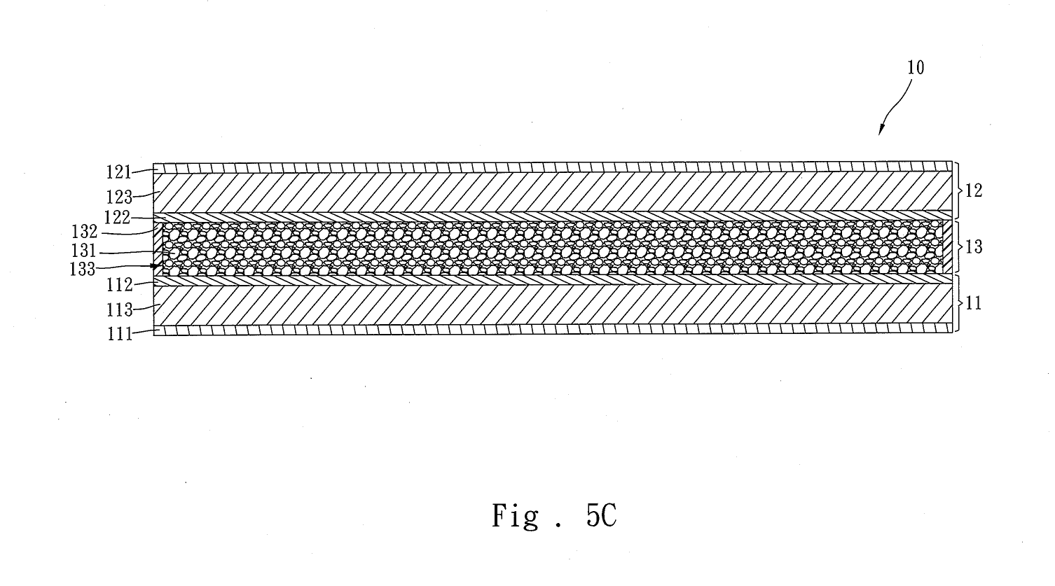

After the first side member 11 and the second side member 12 are completed, the process proceeds to fabricate the electrochemical-catalytic conversion units 10. Refer to FIGS. 5A to 5C diagrams schematically showing a method for fabricating the electrochemical-catalytic conversion units 10 according to one embodiment of the present invention.

Firstly, facing the anode layer 112 of the first side member 11 to the anode layer 122 of the second side member 12 and separating the anode layer 112 of the first side member 11 from the anode layer 122 of the second side member 12 by the accommodation space 133, as shown in FIG. 5A. Next, fill the reducing agent 131 into the accommodation space 133, as shown in FIG. 5B. In one embodiment, the reducing agent 131 is a solid-state reducing powder, such as graphite powders or carbon black. Then, encapsulate the reducing agent 131 inside the accommodation space 133 with an adhesive 132 to form the reducing environment 13, as shown in FIG. 5C. In one embodiment, the adhesive 132 are made of heat-resistant ceramic putty having a thermal expansion coefficient near that of the solid-state oxide layers 113 and 123. The adhesive 132 normally contains aluminum oxides and silicon oxides. Thus is completed the fabrication of the electrochemical-catalytic conversion unit 10. In another embodiment, the accommodation space 133 is not filled with the reducing agent 131 but directly sealed by the adhesive 132, and the pressure inside the accommodation space 133 is lower than 1 atm, e.g., whereby a vacuum state is formed inside the reducing environment 13.

In conclusion, the present invention installs the electrochemical-catalytic conversion units in the front and rear filter boards, which are integrated with the frame body, to form the exhaust-gas decontamination reactor, wherein the cathode layers of the electrochemical-catalytic conversion units can directly contact and decontaminate the exhaust gas without using any additional reducing gas system, whereby the exhaust gas decontamination reactor has a lower fabrication cost and a smaller volume, and whereby the exhaust gas decontamination reactor is less likely to be damaged. Further, the multilayer structure of the exhaust gas decontamination reactor increases the contact area between the reactor and the exhaust gas and thus enhances the decontamination performance of the reactor.

What is claimed is:

1. A multilayer-structured exhaust gas decontamination reactor, comprising:
a frame body including an input end allowing an exhaust gas to enter and an output end allowing the exhaust gas to discharge;
a front filter board arranged inside the frame body and at one side near the input end and a rear filter board arranged inside the frame body and at one side near the output end, wherein the front filter board and the rear filter board respectively include a plurality of filter regions and a plurality of hollow-out interconnection regions, and wherein the filter regions of the front filter board correspond to the interconnection regions of the rear filter board, and the interconnection regions of the front filter board correspond to the filter regions of the rear filter board; and
a plurality of electrochemical-catalytic conversion units each including a first side member, a second side member, and a reducing environment formed between the first side member and the second side member, wherein the first side member and the second side member respectively include a cathode layer, an anode layer and a solid-state oxide layer between the cathode layer and the anode layer, and wherein the anode layer of the first side member faces the anode layer of the second side member and is separated from the anode layer of the second side member by the reducing environment,
wherein the input end, the interconnection regions of the front filter board and the rear filter board, and the output end jointly form a channel allowing the exhaust gas to flow, and wherein surfaces of the cathode layers of the electrochemical-catalytic conversion units are exposed to the channel to function as reaction sides for decontaminating the exhaust gas.

2. The multilayer-structured exhaust gas decontamination reactor according to claim 1, wherein the reducing environment includes an accommodation space and a reducing agent accommodated in the accommodation space.

3. The multilayer-structured exhaust gas decontamination reactor according to claim 2, wherein the reducing environment further includes an adhesive that joins the anode layer of the first side member with the anode layer of the second side member and encapsulate the reducing agent inside the accommodation space.

4. The multilayer-structured exhaust gas decontamination reactor according to claim 1, wherein the reducing environment includes an accommodation space having a pressure lower than 1 atm.

5. The multilayer-structured exhaust gas decontamination reactor according to claim 4, wherein the reducing environment further includes an adhesive that joins the anode layer of the first side member with the anode layer of the second side member to enclose the accommodation space.

6. The multilayer-structured exhaust gas decontamination reactor according to claim 1, wherein the filter regions of the front filter board and the filter regions of the rear filter board are arranged staggeredly.

7. The multilayer-structured exhaust gas decontamination reactor according to claim 1, wherein the filter regions and the interconnection regions of the front filter board are arranged alternately.

8. The multilayer-structured exhaust gas decontamination reactor according to claim 1, wherein the filter regions and the interconnection regions of the rear filter board are arranged alternately.

9. The multilayer-structured exhaust gas decontamination reactor according to claim 1, wherein the cathode layers are made of a material selected from a group consisting of perovskite metal oxides, fluorite metal oxides, metal-added perovskite metal oxides, metal-added fluorite metal oxides, and combinations thereof.

10. The multilayer-structured exhaust gas decontamination reactor according to claim 1, wherein the anode layers are made of a material selected from a group consisting of cermets of metals and fluorite metal oxides, perovskite metal oxides, fluorite metal oxides, metal-added perovskite metal oxides, metal-added fluorite metal oxides, and combinations thereof.

11. The multilayer-structured exhaust gas decontamination reactor according to claim 1, wherein the solid-state oxide layers are made of a material selected from a group consisting of fluorite metal oxides, perovskite metal oxides, and combinations thereof.

12. A method for fabricating a multilayer-structured exhaust gas decontamination reactor, comprising steps of:
preparing a plurality of electrochemical-catalytic conversion units each including a first side member, a second side member and a reducing environment formed between the first side member and the second side member, wherein the first side member and the second side member respectively include a cathode layer, an anode layer and a solid-state oxide layer between the cathode layer and the anode layer, and wherein the anode layer of the first side member faces the anode layer of the second side member and is separated from the anode layer of the second side member to form the reducing environment;
providing a front filter board and a rear filter board that are spaced from each other, wherein the front filter board and the rear filter board respectively include a plurality of filter regions accommodating the electrochemical-catalytic conversion units and a plurality of hollow-out interconnection regions;
letting the filter regions of the front filter board correspond to the interconnection regions of the rear filter board, and letting the interconnection regions of the front filter board correspond to the filter regions of the rear filter board; and
preparing a frame body including an input end and an output end, wherein the front filter board is arranged inside the frame body and at one side near the input end, and wherein the rear filter board is arranged inside the frame body and at one side near the output end, and wherein the input end, the interconnection regions of the front filter board and the rear filter board, and the output end jointly form a channel allowing an exhaust gas to flow, and wherein surfaces of the cathode layers of the electrochemical-catalytic conversion units are exposed to the channel to function as reaction sides for decontaminating the exhaust gas.

13. The method for fabricating the multilayer-structured exhaust gas decontamination reactor according to claim 12, wherein the solid-state oxide layers are made of a material selected from a group consisting of fluorite metal oxides, perovskite metal oxides, and combinations thereof.

14. The method for fabricating the multilayer-structured exhaust gas decontamination reactor according to claim 12, wherein a method for fabricating the first side member comprises steps of:
providing the solid-state oxide layer including a cathode surface and an anode surface far away from the cathode surface;
coating a cathode material on the cathode surface, and performing a first sintering process for the cathode material to form the cathode layer on the cathode surface; and
coating an anode material on the anode surface, and performing a second sintering process for the anode material to form the anode layer on the anode surface.

15. The method for fabricating the multilayer-structured exhaust gas decontamination reactor according to claim 14, wherein the cathode material is selected from a group consisting of perovskite metal oxides, fluorite metal oxides, metal-added perovskite metal oxides, metal-added fluorite metal oxides, and combinations thereof.

16. The method for fabricating the multilayer-structured exhaust gas decontamination reactor according to claim 14, wherein the anode material is selected from a group consisting of cermets of metals and fluorite metal oxides, perovskite metal oxides, fluorite metal oxides, metal-added perovskite metal oxides, metal-added fluorite metal oxides, and combinations thereof.

17. The method for fabricating the multilayer-structured exhaust gas decontamination reactor according to claim 12, wherein a method for fabricating the second side member comprises steps of:
providing the solid-state oxide layer including a cathode surface and an anode surface far away from the cathode surface;
coating a cathode material on the cathode surface, and performing a first sintering process for the cathode material to form the cathode layer on the cathode surface; and
coating an anode material on the anode surface, and performing a second sintering process for the anode material to form the anode layer on the anode surface.

18. The method for fabricating the multilayer-structured exhaust gas decontamination reactor according to claim 12, wherein a method for fabricating the electrochemical-catalytic conversion unit comprises steps of:
facing the anode layer of the first side member to the anode layer of the second side member, and separating the anode layer of the first side member from the anode layer of the second side member by an accommodation space;
filling a reducing agent into the accommodation space; and
encapsulating the reducing agent inside the accommodation space with an adhesive to form the reducing environment.

19. The method for fabricating the multilayer-structured exhaust gas decontamination reactor according to claim 18, wherein the reducing agent is solid-state reducing powders selected from a group consisting of graphite powders or carbon black.

20. The method for fabricating the multilayer-structured exhaust gas decontamination reactor according to claim 18, wherein the adhesive is a ceramic adhesive.

21. The method for fabricating the multilayer-structured exhaust gas decontamination reactor according to claim 12, wherein the filter regions of the front filter board and the filter regions of the rear filter board are arranged staggeredly.

22. The method for fabricating the multilayer-structured exhaust gas decontamination reactor according to claim 12, wherein the filter regions and the interconnection regions of the front filter board are arranged alternately.

23. The method for fabricating the multilayer-structured exhaust gas decontamination reactor according to claim 12, wherein the filter regions and the interconnection regions of the rear filter board are arranged alternately.
